(19) United States
(12) Patent Application Publication
(10) Pub. No.: US 2008/0215356 A1
(43) Pub. Date: Sep. 4, 2008

(54) System and method to administer a patient specific anonymous medical questionnaire over the public Internet using manual decryption of user information

(76) Inventor: Vincent M. Vancho, Trabuco Canyon, CA (US)

Correspondence Address: Vincent M. Vancho, 19 Wakonda, Dove Canyon, CA, 92679, US

(21) Appl. No.: 12/074,022

(22) Filed: Mar. 1, 2008

Related U.S. Application Data
(60) Provisional application No. 60/904,463, filed on Mar. 2, 2007.

(51) Int. Cl. G06Q 99/00

(52) U.S. Cl. 705/1

(57) ABSTRACT

The invention is a system and method for a physician to administer an interactive, branched logic computerized medical questionnaire over a public internet to patients, such that said patients or said physician does not have to be identified on the questionnaire by name, and, therefore, can remain anonymous. The questionnaire is administered on a public Internet site using a personal identification number for the physician which, when interpreted by a third-party database, routes the output to the physician based on information provided by the physician. The output contains patient-related information which only the physician knows. The physician relates the patient information contained in the output, via manual means, to information already known about the patient based on the physician-patient relationship, the patient is identified and the output can be placed within the patients record.

### RELATED U.S. APPLICATION DATA

This application claims the benefit of U.S. Provisional Application No. 60/904,463 filed Mar. 2, 2007

### FEDERALLY SPONSORED RESEARCH

Not Applicable

### SEQUENCE LISTING OR PROGRAM

Not Applicable

### FIELD OF THE INVENTION

The invention is a system and method for a physician to administer an interactive, branched logic computerized medical questionnaire over a public internet to patients, such that said patients or said physician does not have to be identified on the questionnaire by name, and, therefore, can remain anonymous. The questionnaire is administered on a public Internet site using a personal identification number for the physician which, when interpreted by a third-party database, routes the output to the physician based on information provided by the physician. The output contains patent-related information which only the physician knows. The physician relates the patient information contained in the output, via manual means, to information already known about the patient based on the physician-patient relationship, the patient is identified and the output can be placed within the patients record.

This system provides one hundred percent anonymity for both the physician and the patient at the time the patient is actually using the questionnaire, thereby eliminating the need to use any secured website. Even the output from the questionnaire, if printed at the completion of the questionnaire at the time of use, would show no information linking any person to the output.

The manual decryption of the patent identity eliminates the need to have a relational database of patient information connected to a website server.

For the purposes of clearly describing the present invention, the use of the term “physician” and physician's office” is considered to be the same. The term “physician's office” means the collective office staff of the physician, appointed by the physician to have secured access to important medical data or communication, and whether the physician or physician's office personnel actually perform the needed communication and actions to conform to the requirements of the present invention is immaterial to the scope of this invention.

### BACKGROUND OF THE INVENTION

Computerized questionnaires are used to gather data on any number of things. A typical example might be an interactive software algorithm that asks a user what parts of a program he wants loaded and only loads those parts. In this case, there would be no requirement for knowing the person using the program. Also, in this case the program would be wholly run on the user's computer, having been purchased and loaded onto the computer before execution of the program.

In the example above, two key process items are apparent: the first is whether the person needs to be identified at all, and the second is which computer communication protocol runs the program. Regarding user identification, in many cases the user does not need to be identified. Examples might be marketing questionnaires where only the general population data is needed. However, an example of when the user needs to be identified is when the output affects the person directly, such as a medical questionnaire.

Regarding the communication protocol, it's well known in the art that running computer programs falls into three broad classifications: (a) standalone programs, in which the user runs a specific program on a personal, or individual, computer, (b) server/client programs in which a program is run on a main computer server, connected to one or many client computers through a number of communication interface capabilities, and (c) network programs, in which a program is hosted or run on a website server, and a user uses the program by accessing it remotely on a computer connected through Internet protocols.

Security of the host program, and consequently security of user identities, differs in the three protocols. In the standalone program, the user runs the program on a single computer and has complete control of the computer and its security constraints. For server/client programs, users must typically use a computer which is directly connected to a network server, so security of the network can be contained by limiting access to the computers attached directly to the network. When an Internet protocol is used, the host program is run on a website server and accessed from any Internet enabled computer located anywhere in the world, and therefore security on the Internet protocol is the most difficult. Typical security for the website involves using a hardware or software firewall to protect unwanted intrusion from outsiders combined with encrypted communication between the server and Internet enabled computer.

When identification of the user of the questionnaire is needed, all three delivery protocols will require some type of login method. A typical login method requires the use of the user's name and password used in tandem to assure the correct person is allowed to use the program. If the user does not want to be identified, a pseudo name is typically used, and when logging into the host program, the pseudo name is associated with a person's actual name in a separate computer relational database. For the standalone and server/client protocols, the relational database is highly confined, since only users who have access to the host or connected computers—in the server/client model—can access that database. However, in the case of the Internet delivery protocol, the database is typically kept on a computer directly linked to the website server, and is therefore open to attack by “hackers” or people who have knowledge of internet protocol communications and systems, who may use that knowledge to gain access to the host program for malicious intent.

In today's healthcare arena, standalone, server/client, and Internet protocol infrastructures are used throughout the industry for almost all activities, including administering medical questionnaires. Internet protocols are used to a much lesser degree due to the inherent insecurity of their systems, as mentioned above.

In any medical activity involving a patient, including administering medical questionnaires, it's vital that the patient be correctly identified when the data effects the patient At the present time, the Health Insurance Portability and Accountability and Act (HIPAA) defines that protected health information (PHI), which is any information about health status that can be linked to an individual, be safeguarded and protected from disclosure and inappropriate access. Because of the nature of public access using the Internet, securing patient identities during the administration of a medical questionnaire presents a particular challenge.

For example, administering a branched-logic, computerized medical questionnaire over the Internet might require that a physician sets up a website and asks patients to log into said website with a usemame and pass code, then take the questionnaire. In order to protect information being passed between the public computer and the website, an encryption security routine may be run by the website server. In this case, the user's computer may not have appropriate software to run the encryption programs. For example, if the user browser doesn't have 128 bit encryption capability and the website requires it, the transmission may reduce to lesser encryption techniques to match the user computer and host website, or the transmission may not work at all. Additionally, encryption requires the use of transmission bandwidth, so if the user computer does not have sufficient bandwidth the program may have slow response resulting in the user cancelling the session. Finally, when the user is connected to the physician's website, typically the physician and the patient information is presented on the computer screen, so anyone who is standing near the user could identify the person using the program and the physician owning the website.

The above considerations are minor against the more important problem in that the physician must assure that the computer server hosting the website, and connected to a database that relates usemames to actual names, is totally secure from breach by hackers. This is typically done through some type of hardware or software “firewall”, which is designed to prevent intrusion from unwanted users. However, it is not required that websites must use firewall services; therefore, it's possible the website owner does not have such firewalls enabled, and as such the website is open to attach by hackers. If a hacker were able to break into the physician's computer hosting the website, the individual patient information could be vulnerable to public scrutiny.

The situation is independent of whether the physician hosts his own website within his office, or with a third party hosting company.

Additionally, many single practice physicians—physicians who are in solo practices and are not affiliated with any larger group practice—don't even have the need to have a website, making it impossible to even allow public access to any questionnaire they may want to host But physicians do need as much medical information about their patients as they can get. This is particularly true when a patient develops a health related symptom, and needs the physician's care. For example, having the ability to prescreen the patient's illness before seeing the patient is a condition favored by most physicians. Such a screening method can be found in branched-logic computerized medical questionnaires.

The branched-logic, computerized questionnaire is typically specific to the gender and age of the individual, but does not require any identifying information in order to run. However, to interpret the results in the context of a person's overall health status, the physician would need to know who the output belongs to.

If a physician had a website to administer the branched logic medical questionnaire over the Internet protocol, there would be a number of concerns. First, because the patient has to log into the site and be identified in some way to have the output related to the correct person, the website server would have to be connected to a relational database of patient names. As mentioned earlier, this would be vulnerable to attack by hackers on the Internet. Second, while operating the website, the website is typically formatted to provide information to the user. In this case, the website may show the patient's name. It may be possible that a patient needs to use a computer capable of addressing an Internet website from a public access point, such as a library, as some users still lack access to either a computer or if they have computers, may not have communication access via the Internet. So, while the patient is visiting the physician's website to take the questionnaire, and the possibility of having the patient's name visible on the computer screen, it is possible that the patient could be identified by someone passing by the computer.

Therefore, what is needed is a way to administer a branched logic, computerized medical questionnaire over the Internet, which allows access by any public computer, but which the patient cannot be identified by looking at the computer screen, and in which there is no relational database containing the patient's name connected in any way to the website server running the questionnaire. Instead, the output of the medical questionnaire could be sent to the physician, by any number of means, along with information about the patient which only the physician knows and could use to identify the patient. The patient information would be manually related to information the physician knows about the patient to identify the patient, and the output could then be placed within the patient's medical record.

### SUMMARY OF THE INVENTION

The present invention relates to the use of a public accessible website, which a patient can visit, and which contains the infrastructure to run a branched-logic, computerized medical questionnaire. During the website visit, by providing contact information about the patient's physician and some personal information only the physician would know about the patient, the patient can take the questionnaire and have the questionnaire output routed to the physician so that the physician can manually identify the patient and file the questionnaire output in the patient's medical record.

In one aspect of the invention, the branched logic, computerized medical questionnaire is a symptom based medical history questionnaire used to gather medical data about a patient after the patient develops a health issue or symptom. The questionnaire requires the input of the patient's date of birth and gender, but does not require the patients name in order to work properly.

In another aspect of the present invention, the patent can visit the website from any Internet capable computer, either one owned by the patient, or used publicly, such as in a library. The computer does not need any encryption software and no firewall is necessary to access the website.

Another aspect of the invention allows the physician to generate and use a personal identification number, or PIN, which the physician provides to the patient in order to have the questionnaire output sent back to the physician. The PIN would allow the identification of the physician's real contact information to be kept off the computer screen.

In yet another aspect of the proposed invention, personal data about the patent are used to start the questionnaire and which only the physician knows about the patient. These are usually informational items that are located in the patient's medical record or office environment.

According to another aspect of the invention, output from the medical questionnaire can be sent to the physician, along with the patient information, using various means including faxing, email, postal courier, or any other standard communication mechanism. The output can be produced using standard HTML formatting and may be converted to any of a number of formats including standard graphical formats such as TIF, PDF or any commercial word processing format, and manually printed by the physician.

When said output is received by the physician or physician's office and subsequently identified, it can be printed and placed within a physical file folder used as the patient's record, or if sent in computer readable format, moved into any electronic medical record file which can accept said format.

### BRIEF DESCRIPTION OF THE DRAWINGS

All drawings are made to describe the preferred embodiment of the system.

FIG. 1 shows an Internet physician registration website whereby a physician can register into the system, provide a best means of receiving questionnaire output, and receive a PIN.

FIG. 2 shows a schematic overview of the present invention showing the communication flow among the patient, the medical questionnaire website, a fax server, and the physician's office.

FIG. 3 lists items that a patent would do while accessing the medical questionnaire website, plus the actions that are taken within the website after the patient completes the questionnaire.

FIG. 4 presents a schematic listing the functions that are done when the questionnaire output is sent to the fax server.

FIG. 5 shows the methods associated with the physician's office.

FIG. 6 shows the process to identify the true patient when multiple patients are scheduled at the same time in a physician's office.

### DETAILED DESCRIPTION OF THE INVENTION

The following description provides a detailed description of the preferred embodiment of the invention.

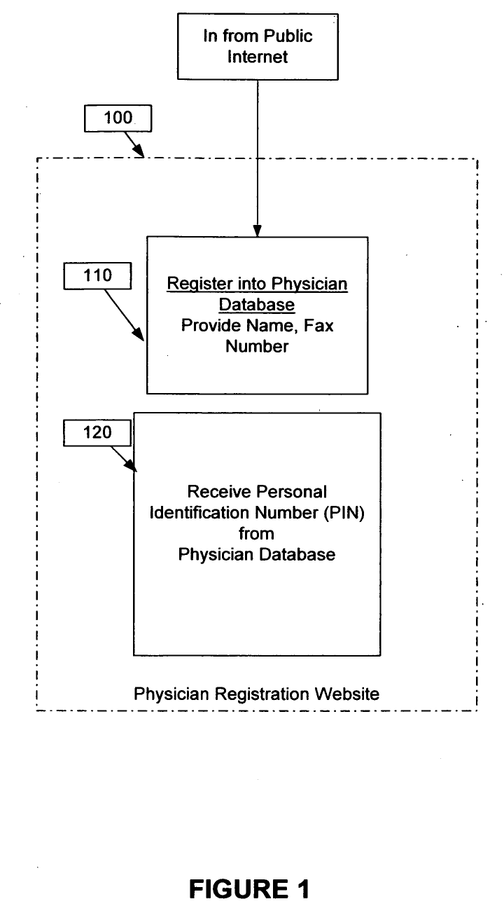

Referring to FIG. 1, the preferred embodiment is illustrated by having the physician register into a physician registration website [100] using the Internet protocol, and any available means of connection to the Internet. Within this website, the physician can further register into a physician database [110] which will authorize the physician to use the system defined by the present invention. The purpose of this registration is so that the physician can provide fax number information which will allow desired questionnaire output concerning the patient to be sent to the physician via fax. Additionally, the physician would receive a personal identification number (PIN) [120] which can be used in place of the physician's name, which would keep the physician's name and fax number a secret to any persons except the patient for the purpose of using the present invention. One primary reason for hiding the physician's name from use on the medical questionnaire is that many physicians consider their fax number to be private and intended only for medical information, and want it restricted; therefore, having a PIN to replace the fax number serves to protect the physician's office from getting unwanted non-medical faxes.

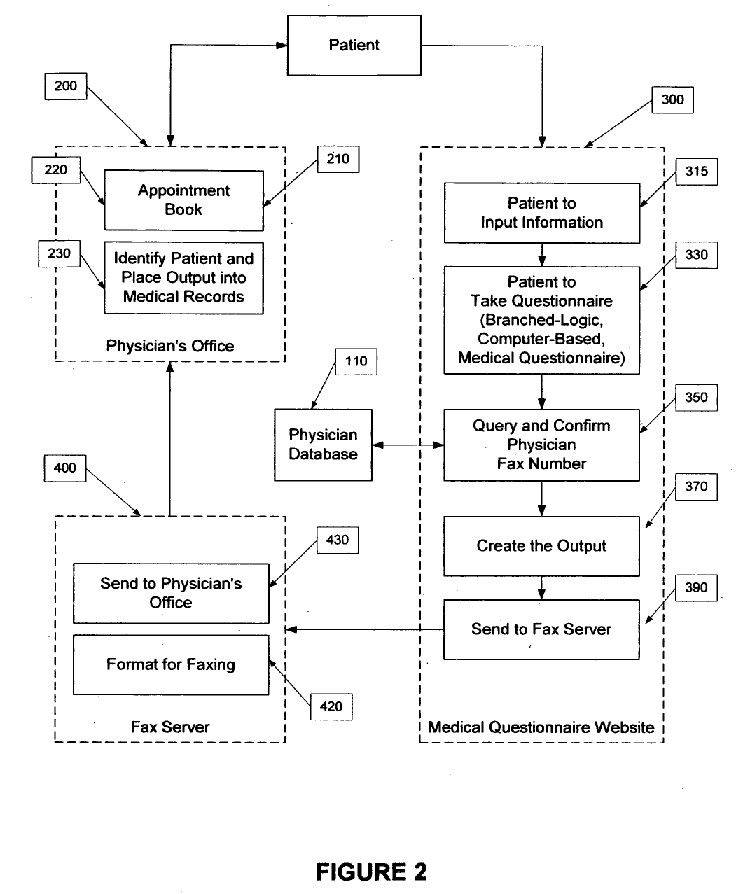

Referring to FIG. 2, which is an overall system overview, the process starts with a patient scheduling an examination appointment with their physician's office [200]. The appointment can be made in person or on the phone, and is typically logged into the physician's office appointment book [210]. At the time of making the appointment, the physician or the physician's office instructs the patient to take a medical history questionnaire [330] which will provide the physician with important details of the patients current medical condition. The patent is instructed to go to a public Internet website shown in FIG. 2 as the medical questionnaire website [300] where the medical history questionnaire is provided, and the patient is provided with the physician's PIN number and reminded by the physician to enter the appointment time and date on the questionnaire.

At any time between making the appointment and coming into the physician's office for the appointment, the patient would visit the medical questionnaire website [300] using the Internet protocol, and input information [315] consisting of the physician's PIN and appointment time and date provided by the physician. This website is accessed by using any standard connection to the internet, and may include the patent's own personal computer, or a public computer such as may be found in a public library. Within the website, the patient takes the medical questionnaire [330] without having to provide any information which can identify the patient. In the preferred embodiment of the present invention the medical questionnaire is a branched logic, computerized medical questionnaire which requires the patient's age and gender in order to better understand the medical condition of the patient.

After taking the questionnaire, the physician's fax number is determined [350] by querying for the physician's PIN in the physician database [110], and returning the physician's fax number to the query routine [350]. All the information, once received, is formatted into output [370] and sent to a Fax Server [390]. The output contains the medical information resulting from the questionnaire, plus the appointment time and date, plus the patient's age and gender. Once received at the Fax Server [400] the output is formatted for faxing [420] and sent to the physician's office by fax [430] using available standard fax processing technology

Once the fax is received by the physician's office [200], the patient is identified [220] and the output is placed into the patients medical record [230].

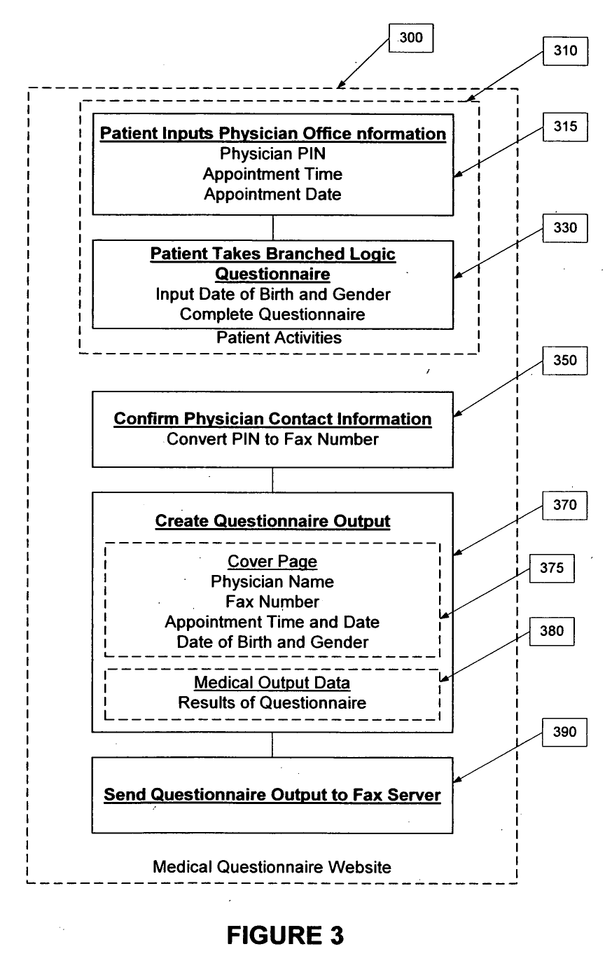

FIG. 3 shows additional detail for the Medical Questionnaire Website [300] where the patient goes to take the medical questionnaire. In the preferred embodiment the medical questionnaire is a branched-logic computerized questionnaire that requires input of parameters such as the patients date of birth and gender.

A branched logic computer driven medical questionnaire is a class of computer based questionnaires in which a patient picks a general symptom or medical issue, and the computer begins a series of questions related to the symptom. Based on the previous answer, the computer will ask different questions about the person's family history, or present condition. For example, if the questionnaire asks whether a patient has a back problem, and the patient answers yes, the logic will begin a series of questions related to back issues. Additionally, the questionnaire is gender specific. As an example, if gender were not known, the questionnaire may delivery questions related to child bearing to a man. The questionnaire is also age specific so that so, for example, the questionnaire would not ask prostate questions to a teenager.

Referring again back to FIG. 3, the patient can access the medical questionnaire website [300] by using the Internet protocol. Upon entering said website, the patient activities [310] include entering information which consists of two different types of data. The first is the information associated with the physician and physician's office [315] which includes the physician's PIN, and the scheduled appointment time and date made with the physician. The second set of data is gotten by starting the branched logic questionnaire [330], and consists of the patents own date of birth and gender required by the branched logic questionnaire in order to operate effectively. Once the questionnaire is completed, the physician's PIN number is cross referenced to the physician's fax number [350] using the physician database [110]. After all the necessary information is gotten, the questionnaire output is created [370], which consists of a Cover Page [375] providing the physician's name, fax number, appointment date and time, and patients date of birth and gender, plus the medical output data [380] which are the results of the medical questionnaire and is specific to the patient. The questionnaire output is properly formatted and sent to the fax server [390].

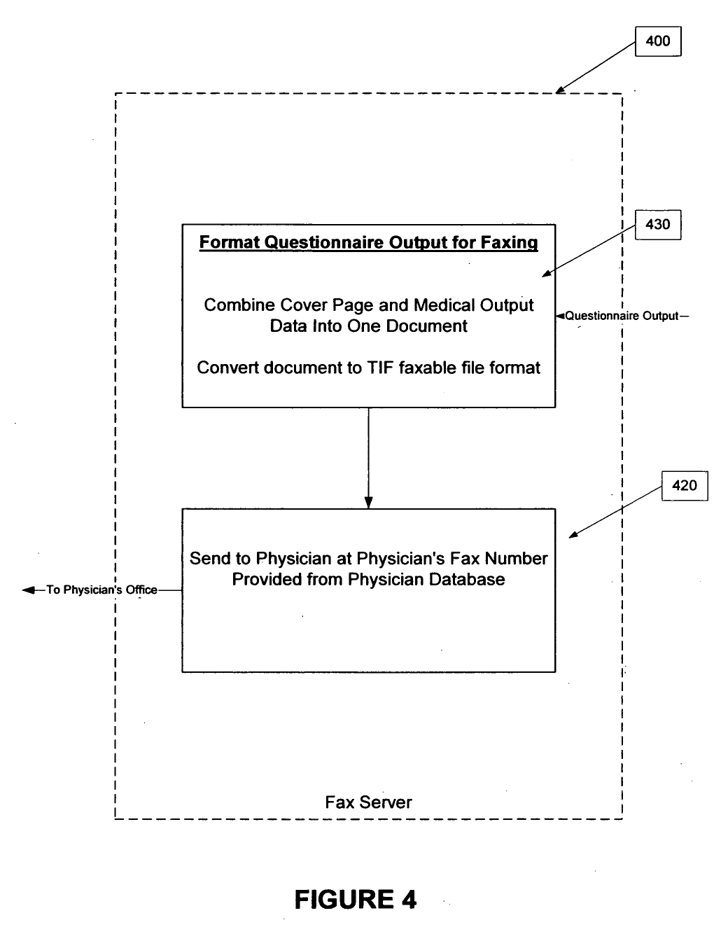

Referring now to FIG. 4, which shows the operation of the Fax Server [400], questionnaire output is received from the medical questionnaire website where the cover page and medical output are combined into a single document for faxing [430]. In order to accomplish this, the document is converted into a typical graphical file format call a TIF file. This file is then sent to the fax number provided by the physician when signing into the system on the physician's database [420].

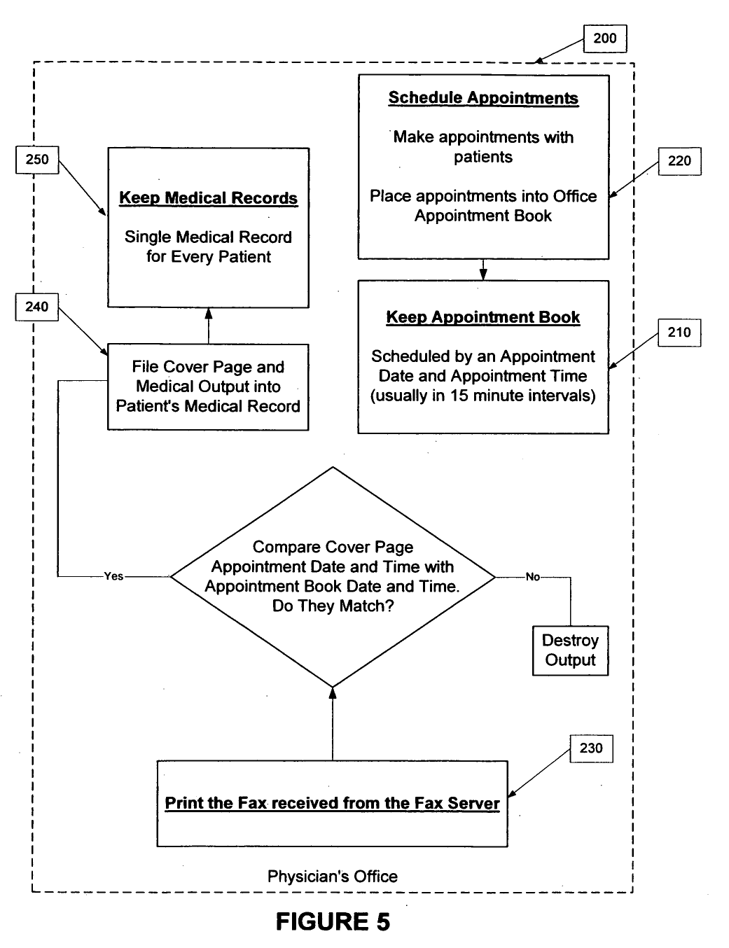

Referring to FIG. 5, after the questionnaire output is received by fax at the physician's office [200], the fax is printed [230] and the appointment date and time from the cover page is compared with the same appointment date and time contained in the physician's appointment book [210]. Once matched up, the name of the person listed in the appointment book for that date and time is considered the true patient of record, and the cover page and medical output is placed into that patient's medical record where it can be reviewed by the physician prior to the patients visit [240][250].

It is typical within the medical industry for physicians to schedule appointments within a 15 minute time period; therefore, most appointments are scheduled within the quarter hour interval. Some physicians tend to schedule more than one appointment at a time, which can lead to having conflicting information regarding the patient's true identity.

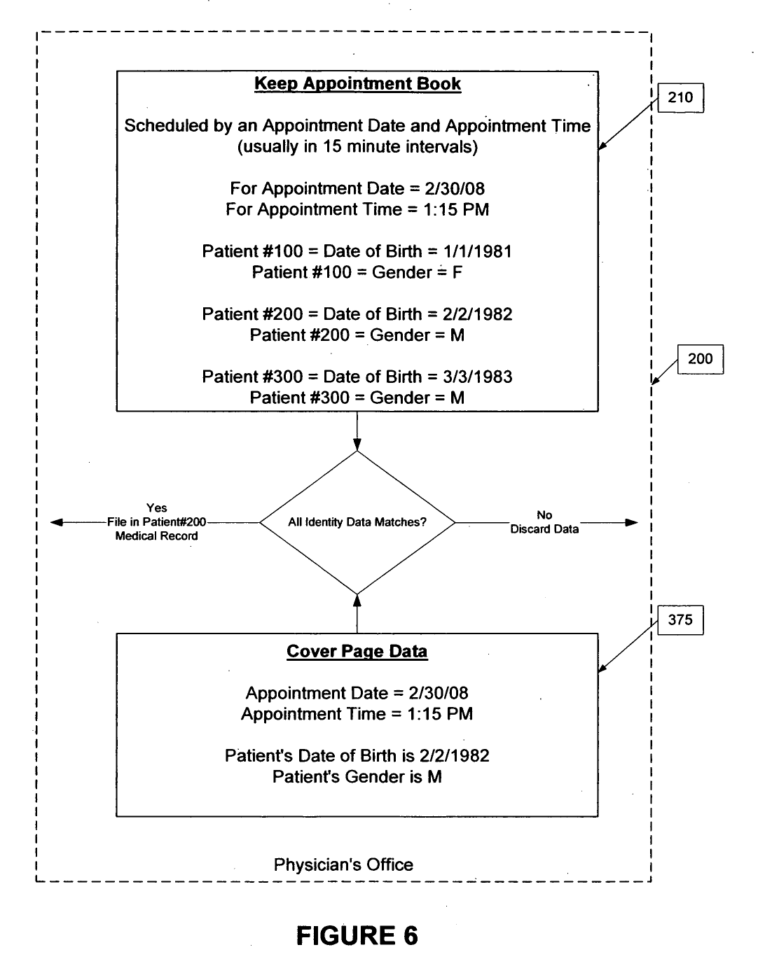

A solution to this is presented in FIG. 6, which shows the method for discerning the most probably patient when many patients are scheduled at one time by the physician's office [210].

The cover page data [375] contains the additional data of the date of birth and gender of the patient. This data, when combined together with the appointment time and date has been calculated to result in a probability of more than 99% to identify the one true patent In FIG. 6, an example is presented of three patients scheduled on the same date of Feb. 20, 2008. The cover page data indicates that the patient is one of the three scheduled at that time. The additional data of date-of-birth and gender provide sufficient data to identify patient #200 as the one true patient. Once the confirmation is completed, the medical output can be placed into the medical record of patient [240][2501.

In an alternative embodiment of the invention, the physician may choose not to use faxing as the preferred communication, but rather to use email. In this case the physician's PIN would relate to the physician's email instead of his fax, and the delivery protocol would be by using an email server to send the email via the Internet instead of a fax server using standard fax lines to deliver the fax.

When email is used as an alternative embodiment of the invention, a number of enhancements can be made when the questionnaire output is created. The cover page and medical output can be combined and formatted into a file format know as PDF which is a common file structure for reading documents sent over the Internet, and allows the questionnaire output to be sent as an attachment to the email address to the physician. The PDF file format allows the questionnaire output attachment to be opened by any computer which has the software known as Adobe Reader. Once the file is opened and the patient is identified, the entire file can either be printed and placed into the paper-based medical record of the patient, or it may be moved directly into the patient's electronic medical record (EMR), should the physician have an EMR program installed in his practice.

Another alternative embodiment of the present invention is that the physician may choose not to register for a PIN, but rather prefer to provide his actual fax number or email address to the patient. In this case there is no need to convert the PIN number to a fax or email, but the questionnaire output is sent exactly the same way as the preferred embodiment and the manual identification of the patient is still done in the same way.

In still another alternative embodiment of the present invention, the physician may choose to use a unique identification number of the patient instead of using the appointment book appointment time and date. Such a unique number may exist, for example, if the physician has a computerized patient record system and each patient is assigned a unique number by the computer system. In this case the physician simply provides the patient with the unique patient ID in addition to the physician PIN number or the physician's direct fax or email address. Since the unique ID number provides a true identification of the patient, the need to have a branched logic computerized questionnaire is not needed, as the additional identifiers of date of birth and gender would not be needed. Therefore any type of questionnaire could be used and the patient would be fully identifiable.

I claim:

1. A system and method for a physician to administer an Internet based branched logic computerized medical questionnaire to patients, which keeps the physicians' and patents' identity anonymous while the patient is using the questionnaire from any Internet enabled computer run over the public Internet, through the use of information known only by the physician and patient, and which information is decoded manually by the physician to protect patent identity, said system and method comprising:
(a) a physician registration website hosting a physician database where a physician can register his name and fax number, and receive a personal identification number (PIN) which can be provided to his patients;
(b) the setting of an appointment between the physician and patient which identifies a specific date and time for which the patient should visit the physician's office to discuss a medical symptom or problem;
(c) the physician providing the patient with his PIN, and directing the patient to a medical questionnaire website where the patient can take a branched logic computerized medical questionnaire;
(d) the patient visiting the medical questionnaire website hosting said branch logic computerized medical questionnaire, and registering using the physician PIN number and appointment time and date, then including additional data of the patient's date of birth and gender required by the branched logic computerized medical questionnaire;
(e) when the questionnaire is completed, output from the questionnaire is formatted and the PIN number is decoded automatically between the medical questionnaire website and the physician registration website containing the physician database to retrieve the physician's fax number;
(f) converting the questionnaire output into a cover page with the physician's fax number, appointment date and time and patient date of birth and gender, and a medical output consisting of the results of the branched logic computerized medical questionnaire, then combining said cover page and said medical output into one electronic file known as a TIF file, which is the typical graphics file format for faxing;
(g) Sending the cover page and medical output to the physician's fax number by means of a fax server;
(h) when the physician receives the questionnaire output, the appointment time and date on the cover page is compared to the appointment time and date in the physician's appointment book;
(i) the physician then identifies any and all patients listed in the physician's appointment book at said appointment time and date, and retrieves the medical file records of all said patients;
(j) the physician compares the date of birth and gender listed on the cover page with the date of birth and gender of all patients whose medical file records were retrieved, and finds the true unique patient whose date of birth and gender matches the date of birth and gender listed on said cover page; and
(k) the physician files the cover page and medical output of the matched patent into the medical record file of the true unique patient.

2. A system and method for a physician to administer a medical questionnaire to their patients, which keeps the physicians' and patents' identity anonymous while the patent is using the questionnaire from any Internet enabled computer run over the public Internet, through the use of information known only by the physician and patient, and which information is decoded manually by the physician to protect patient identity, said system and method comprising:
a) a physician registration website hosting a physician database where a physician can register his name and fax number, and receive a personal identification number (PIN) which can be provided to his patients;
b) the physician providing each patient with a unique patient identification number (ID) by means of a patient database or independent medical record program which relates the patient name to any unique identification number;
c) the physician providing the patient with the PIN and patient ID, and directing the patient to a medical questionnaire website where the patient can take a medical questionnaire;
d) the patient visiting said medical questionnaire website hosting said medical questionnaire, and registering using the physician PIN and patent ID;
e) when the questionnaire is completed, output from the questionnaire is formatted and the PIN number is decoded automatically between the medical questionnaire website and the physician registration website containing the physician database to retrieve the physician's fax number;
f) converting the questionnaire output into a cover page with the physician's fax number and the patient ID, and a medical output consisting of the results of the medical questionnaire;
g) sending the cover page and medical output to the physician's fax number by means of a fax server;
h) when the physician receives the questionnaire output, the physician compares the patient ID on the cover page of the questionnaire output to the list of ID numbers in the patient database and finds the ID in the patient database that matches the ID on the cover page; and
i) the physician files the cover page and medical output into the paper based medical record file of the patient who is associated with the said uniquely matched patient ID number.

3. A system and method for a physician to administer an Internet based branched logic computerized medical questionnaire to their patients, which keeps the physicians' and patients' identity anonymous while the patient is using the questionnaire from any Internet enabled computer run over the public Internet, through the use of information known only by the physician and patient, and which information is decoded manually by the physician to protect patient identity, said system and method comprising:
a) a physician registration website hosting a physician database where a physician can register his name and email address, and receive a personal identification number (PIN) which can be provided to his patients;
b) the setting of an appointment between the physician and patient which identifies a specific date and time for which the patient should visit the physician's office to discuss a medical symptom or problem;
c) the physician providing the patient with the PIN, and directing the patent to a medical questionnaire website where the patient can take a branched logic computerized medical questionnaire;
d) the patent visiting said medical questionnaire website hosting said branch logic computerized medical questionnaire, and registering using the physician PIN number and appointment time and date, then including additional data of the patient's date of birth and gender required by the branched logic computerized medical questionnaire;
e) when the questionnaire is completed, output from the questionnaire is formatted and the PIN number is decoded automatically between the medical questionnaire website and the physician registration website containing the physician database to retrieve the physician's email address;
f) converting the questionnaire output into a cover page with the physician's email address, appointment date and time and patient date of birth and gender, and a medical output consisting of the results of the branched logic computerized medical questionnaire, and combining said cover page and said medical output into one electronic file known as a PDF file, which is a common file used in Internet protocol to read documents sent over the Internet;
g) sending to the physician's email address associated with the physician's PIN an email containing the PDF file as an attachment comprising the cover page and medical output embedded into one file;
h) when the physician receives the email, said physician can open the PDF file and review the questionnaire output, and compare the appointment time and date on the cover page to the appointment time and date in the physician's appointment book;
i) the physician then identifies any and all patients listed in the physician's appointment book at said appointment time and date, and retrieves the medical file records of all said patients;
j) the physician compares the date of birth and gender listed on the cover page with the date of birth and gender of all patients whose medical file records were retrieved, and finds the unique patient whose date of birth and gender matches the date of birth and gender listed on said cover page; and
k) at this point the physician can either print out the PDF file containing the cover page and medical output and store the printout into the patient paper-based medical record, or if the physician has an electronic medical record system for keeping patient data, move the electronic PDF file into the electronic medical record of the patient.

4. A system and method for a physician to administer a medical questionnaire to their patients, which keeps the physicians' and patients' identity anonymous while the patient is using the questionnaire from any Internet enabled computer run over the public Internet, through the use of information known only by the physician and patient, and which information is decoded manually by the physician to protect patient identity, said system and method comprising:
a) a physician registration website hosting a physician database where a physician can register his name and email address, and receive a personal identification number (PIN) which can be provided to his patients;
b) the physician providing each patient with a unique patent identification number (ID) by means of a patient database or independent medical record program which relates the patient name to any unique identification number;
c) the physician providing the patient with the PIN and patient ID, and directing the patient to a medical questionnaire website where the patient can take a medical questionnaire;
d) the patient visiting said medical questionnaire website hosting said medical questionnaire, and registering using the physician PIN and patient ID;
e) when the questionnaire is completed, output from the questionnaire is formatted and the PIN number is decoded automatically between the medical questionnaire website and the physician registration website containing the physician database to retrieve the physician's email address; and
f) converting the questionnaire output into a cover page with the physician's email address, appointment date and time and patient date of birth and gender, and a medical output consisting of the results of the branched logic computerized medical questionnaire, and combining said cover page and said medical output into one electronic file known as a PDF file, which is a common file used in Internet protocol to read documents sent over the Internet;
g) sending to the physician's email address associated with the physician's PIN an email containing the PDF file as an attachment comprising the cover page and medical output embedded into one file;
h) when the physician receives the email, the physician can open the PDF file and review the questionnaire output, and compare the patient ID to the list of ID numbers in the patient database and find the ID in the patient database that matches the ID on the cover page;
i) the physician can either print out the PDF file containing the cover page and medical output and file the cover page and medical output into the medical record file of the patient who is associated with the unique patient ID, or if the physician has an electronic medical record system for keeping patient data, move the electronic PDF file into and electronic medical record of said patient.
